(19) United States
(12) Patent Application Publication
(10) Pub. No.: US 2025/0208693 A1
(43) Pub. Date: Jun. 26, 2025

(54) MANAGEMENT OF SUPPLY CURRENT IN SHARED DOMAINS

(71) Applicants: Nilanjan PALIT, Northborough, MA (US); Ankush VARMA, Portland, OR (US); Adwait PURANDARE, Beaverton, OR (US); Shruthi VENUGOPAL, Austin, TX (US); Vivek GARG, Folsom, CA (US); Nikethan Shivanand BALIGAR, Hillsboro, OR (US); Eric J. DEHAEMER, Shrewsbury, MA (US)

(72) Inventors: Nilanjan PALIT, Northborough, MA (US); Ankush VARMA, Portland, OR (US); Adwait PURANDARE, Beaverton, OR (US); Shruthi VENUGOPAL, Austin, TX (US); Vivek GARG, Folsom, CA (US); Nikethan Shivanand BALIGAR, Hillsboro, OR (US); Eric J. DEHAEMER, Shrewsbury, MA (US)

(21) Appl. No.: 18/394,238

(22) Filed: Dec. 22, 2023

(51) Int. Cl. G06F 1/3296; G06F 1/329

(52) U.S. Cl. CPC G06F 1/3296; G06F 1/329

(57) ABSTRACT

In some embodiments, a proactive Icc_max_p provisioning scheme is provided. when some domains need to achieve peak performance (e.g., frequency), other domains are limited proactively to ensure that total Icc_max_p can stay within the predetermined limits.

### TECHNICAL FIELD

Embodiments of the invention relate to the field of integrated circuits, and more specifically, to the field of managing current in multi-domain systems.

### BRIEF DESCRIPTION OF THE DRAWINGS

The disclosure may best be understood by referring to the following description and accompanying drawings that are used to illustrate embodiments of the invention. In the drawings:

FIG. 1 is a block diagram showing a system on package processing system in accordance with some embodiments.

FIG. 2 is a flow diagram showing a routine 201 for selecting a peak current limit (PCL) policy in accordance with some embodiments.

FIGS. 3A-3C are diagrams illustrating an exemplary SoP processing system in accordance with some embodiments.

FIG. 4 illustrates an example computing system in accordance with some embodiments.

FIG. 5 illustrates a block diagram of an example processor that may be used in the system of FIG. 4 in accordance with some embodiments.

### DETAILED DESCRIPTION

System on a package (SoP) integrated circuit (IC) processing systems can include numerous dies (or chiplets) performing various different functions such as compute, graphics, communications fabric, memory, task acceleration, and the like. They are typically designed using power delivery budgets that are defined before full knowledge of specific power consumption characteristics for the constituent chiplets, making it extremely challenging to later manage overall package supply power and still facilitate high operational performance.

Power consumption has several critical parameters that determine platform power delivery sizing. Maximum package peak current (Icc_max_p) is one such parameter. Icc_max_p is a burst limit, the peak current that the package can tolerably consume and this, only for a limited amount of time, e.g., less than a few hundred nano seconds. Violation of the Icc_max_p limits are highly problematic since they can result in soft (undetected) errors resulting in compromised security and unreliable, and potentially undetectable, processing results.

Historically, Icc_max_p limit violations have been avoided by imposing Icc_max_p limits for each power domain within a package with overall package limit being based on the sum of each of these constituent peak max limits. This strategy is based on a worst-case scenario assumption where power is being consumed with all cores running at worst-case maximum possible workloads, all fabrics running at maximum bandwidth and all other functional blocks running at maximum turbo frequencies. Unfortunately, this approach has several drawbacks. It usually results in a very large Icc_max_p forecast for which the platform will have to be provisioned but may never see in the lifetime of the product. In addition, process variations, changes in definitions of the virus workload or maximum theoretical value, late changes in the design (more or different IPs) and other excursions late in the design process, can cause the SoP to exceed the forecasted worst-case Icc_max_p value anyway. In such situations, since the platform at this development stage cannot normally be modified, the platform is forced to reduce the maximum allowable peak currents (and thus performance in terms of frequencies) for the different domains, causing the SoP to have reduced performance.

Another approach would be to implement a reactive scheme. A reactive scheme is one where a sensor detects an Icc_max_p excursion (di/dt event) and rapidly throttles the domains to reduce their power consumption to keep overall peak package current below the Icc_max_p spec that the platform has been provisioned. Unfortunately, reactive schemes require detection, communication and response, all to occur within an extremely short amount of time (e.g., the 100 or so nS timeframe mentioned above). This can be extremely difficult, especially with modern disaggregated architectures employing heterogenous collections of both internal and third-party chiplets.

Another challenge is that defining and detecting a virus vs. a worst-case real-world app in a dynamic & heterogenous setup is very difficult. In addition, the definitions of worst-case scenarios can evolve over time based on new workloads/usage models and vary with process shifts. Accordingly, a new approach for managing system on package allowable peak supply current allocations would be desired.

In some embodiments, a proactive Icc_max_p provisioning scheme is provided. when some domains need to achieve peak performance (e.g., frequency), other domains are limited proactively to ensure that total Icc_max_p can stay within the predetermined limits. A proactive scheme can provide a robust, deterministic behavior to meet pre-defined Icc_max_p limits. For example, if a SoP's definition changes with modified or new chiplets, process shifts resulting in higher SoP power consumption, or frequencies needing to be adjusted, the SoP domain policies can be adjusted without grossly impacting performance of other workloads or violating the platform power delivery constraints.

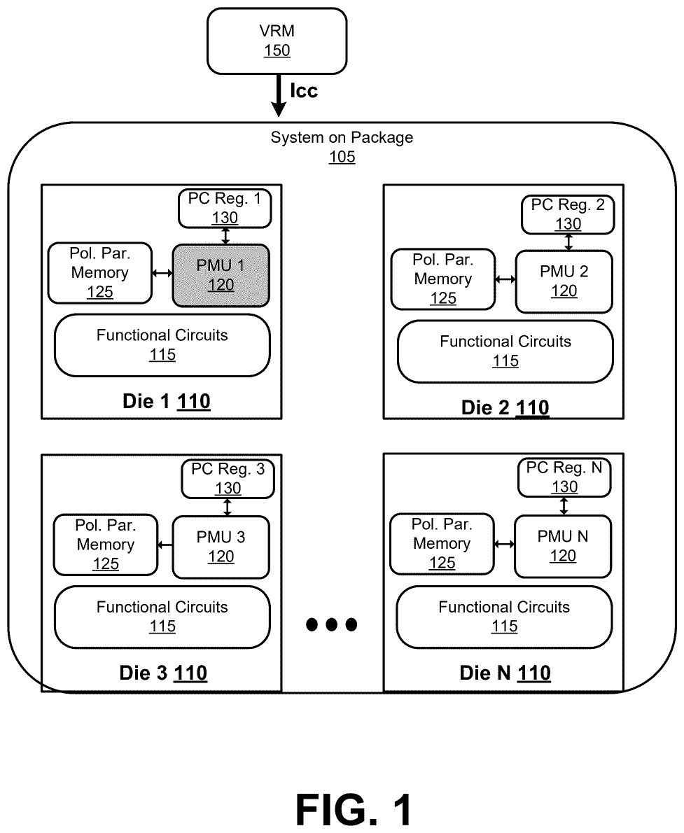

FIG. 1 is a block diagram showing a system on package processing system (hereinafter referred to as processing package) 105 in accordance with some embodiments. Processing package 105 receives supply power for the entire package from voltage regulator module (VRM) 150 providing to package 105 package supply current (Icc). (Note that the VRM may actually comprise multiple voltage regulators providing power to package 105 over multiple rails. VRM 150 represents the ultimate package power source for which Icc_max_p is defined and applied.)

The processor package 105 includes one or more dies 110 (Die 1-Die N in this depiction) coupled together through inter-package communications interfaces (not shown) using a die-to-die (D2D) interconnect scheme such as a Universal Chiplet Interconnect Express (UCIe) interconnect.

Each die 110 has functional circuits 115 such as cores, fabrics, intellectual property (IP) circuits, memory and the like, along with a power management unit (PMU) 120 with memory 125 and register 130 coupled as shown. Memory (e.g., ROM or writeable non-volatile memory) 125 stores policy parameters, while registers 130 are used for policy control (PC), in order to control the domains (e.g., dies) to be in an appropriate Icc_max_p policy. (Note that peak current limit (PCL) policies are primarily discussed with respect to controlling aggregate package current arising from a package's constituent current-consuming chiplets, or dies, but these concepts also apply to controlled domains within a single or several dies. Unless indicated to the contrary, a domain may refer to either a power domain within a die, an entire die, or a combination of dies as domains and domains within dies.)

In some embodiments, each die, e.g., as part of its policy parameter memory 125, may have a look-up table implemented in fuses, other ROM or other non-volatile memory, to map peak current limit policies to a set of constraints specific to the die/type, which can include maximum frequency for its domain(s). The policies have normalized current limit (CL) factors (or values), one for each domain (e.g., die) for each policy within a set of possible policies. The die can then take the CL factor from the identified policy for its domains) and apply accordingly. The memory may also include information for translating the CL factor into a meaningful power cap value such as max aggregate frequency for the domain, max current itself, or some other parameter that corresponds to the dies peak current consumption.

The PMUs 120 include one or more microcontrollers, state machines and/or other logic circuits for controlling various aspects of their associated die 110. For example, they may manage functions such as security, boot configuration, and power and performance including utilized and allocated power along with thermal management for their die. The PMU may also be referred to as a P-unit, a power management controller (PMC), a power control unit (PCU), a system management unit (SMU) and the like and may include multiple controllers. The PMUs each execute firmware and/or logic circuit routines to perform their various functions. Among these functions are controlling their associated die to operate within the set Icc_max_p limit imposed by a presently-engaged package policy. They read package policy parameters from memory 125 in order to interpret policy identifiers and specific policy instantiation Icc_max_p limits, along with other associated parameters.

In some embodiments, pre-defined Icc_max_p limits are provided using normalized maximum frequency CL factor limits as proxies for Icc_max_p limits. In turn, the peak current limit (PCL) policies impose peak aggregate die frequency limits on the various dies to meet the Icc_max_p limits. The PCL policy constraints are encoded into a set of peak frequency limit policies indicated, for example, by a policy identifier such as a policy number. Each policy instance allocates different fractions of the overall package peak current limit to each domain. The individual domain limits will typically be reflected as a pre-defined set of normalized frequency cap limits for each domain.

Note, however, that policies do not only have to use frequency limits to enforce peak current limits. In some embodiments, values corresponding to current, directly or in indirect ways, could be used. The electrical/performance constraints that need to be enforced per a given policy may be different for some domains. While a frequency ceiling may be the most common enforcement mechanism for domains that support dynamic frequency scaling, it can include one or more other constraints, e.g. . . . , number of enabled cores or IPs (which may include parameters such as dynamic capacitance and maximum allowed junction temperatures.

The depicted implementation uses a hierarchical power management (HPM) scheme with one of the PMUs acting as the root (manager), while the others act as roots (managee). In FIG. 1, the shaded PMU (PMU-1) is the root PMU. The root PMU manages the SoP level constraints and distributes die-level limits to each domain. This re-distribution, done based on global telemetry/heuristics, may dynamically be performed hundreds of times a millisecond, for example, by the PMU's central firmware agent running within the root PMU. The remaining domain PMUs act as leaves, where they dynamically constrain their domain's performance to the global frequency (Icc_max_p) limits set by the root. Note that multiple levels of hierarchy are possible and the peak current limit policies constraints can be managed as a flat set of constraints or hierarchically at each level. The hierarchical and monolithic schemes can co-exist, where the root die distributes the global budget to the leaf chiplets and each chiplet, if it has more than 1 performance domain can in turn distribute its allocated budget among the local domains within its associated die. Thus, it is the responsibility of each PMU (including both the root and leaf PMUs) to manage and enforce these frequency limits aggregately on its associated die domain blocks.

It has been observed that minimum required quality of service (QOS) requirements can be satisfied at identified baseline aggregate frequency limitations that are lower than the max frequency limits that can be used to satisfy overall package Icc_max_p thresholds. Frequency increases for any of the domains above their respective base frequencies are allowed but constrained by the PMUs in accordance with a presently-engaged PCL policy. In this way, a unified policy interface can be used while allowing each domain to innovate and apply its constraints in a manner that is local in scope and not overly managed by global (tops-down) design restrictions. Furthermore, it can be adapted to a wide range of SoP types while keeping the power management scheme invariant to the design choices.

The PCL policies may be constructed in any suitable manner. At a high level, they can be fairly simple in that they comprise a set of max frequency limits, one in each set for each domain being regulated. The specific frequency limit values should be defined in a way that can be normalized across the different domains/chiplets allowing the domains to effectively allocate their current budgets (frequency limits) to achieve desired performance while not causing peak current limits to be violated.

Having many different sub domains and functional blocks, individual chiplets can be extremely complicated. It is difficult to accurately monitor and control at the same time all of the individual domains that make up an SoP. However, it turns out that their power consumption and performance can be accurately controlled, indirectly, by controlling their overall frequency consumptions. Power consumption and performance can be correlated with operating frequencies of their constituent sub-domains, which are weighted and added together to arrive at overall domain frequency values that correlate with domain performance capability and power consumption. For example, cores, memory and fabrics are all typically driven by clocks operating at frequencies that directly relate to performance and power. Therefore, each sub domain can be analyzed, for example, through testing or modeling, to correlate their sub-domain operating frequencies with performance and current consumption. The sub-domain frequency functions can then be appropriately weighted and combined with one another to arrive at an overall domain power/performance frequency function, which can be used for allocating package resources to each domain within the confines of an overall package frequency budget.

In some embodiments, a baseline frequency value for the domain is identified. This, in essence, is a frequency budget value that gives the domain enough frequency (power) to effectively perform its expected functions. Again, however, the domain PMU is free to allocate this domain level budget however it wishes to its constituent sub-domains. In some embodiments, this baseline frequency is normalized to a value of 1.0. In any policy, each domain receives at least a max frequency limit of 1.0 but depending on the policy, may receive a higher level greater than 1.0. In this way, the PCL policies can convey frequency limits using normalized values. This is extremely powerful because it allows for dies/domains to be removed, added, or otherwise modified without having to overhaul the entire hierarchical power management scheme for the SoP. Instead, policies can be removed, added or modified and new domains, simply have to be programmed in accordance with the utilized PCL policy methodology. This allows for a correct-by-construction approach to meet a provisioned package and platform power delivery target that can be resilient to late design perturbations in die/package combinations or process/design excursions while meeting performance requirements across a broad set of workloads and performance scenarios.

This approach works because, among other reasons, SoPs are made up of diverse domains that all do not need to operate at turbo performance levels at the same time. For example, workloads may be core-bound or memory bound, but are rarely, if ever, both. This is because it's almost impossible to fully occupy all core resources while also, simultaneously, maximizing all un-core resources across all domains and sub-domains. Under normal steady-state operation, they will not require max performance at the same time, and the proactive max frequency limit policies ensure that the SoP does not encounter such a scenario in transient cases either. Different policies are defined that provide a menu of different domain frequency limit combinations providing the system (root PMU) with the ability to select one of them that suits an observed workload scenario.

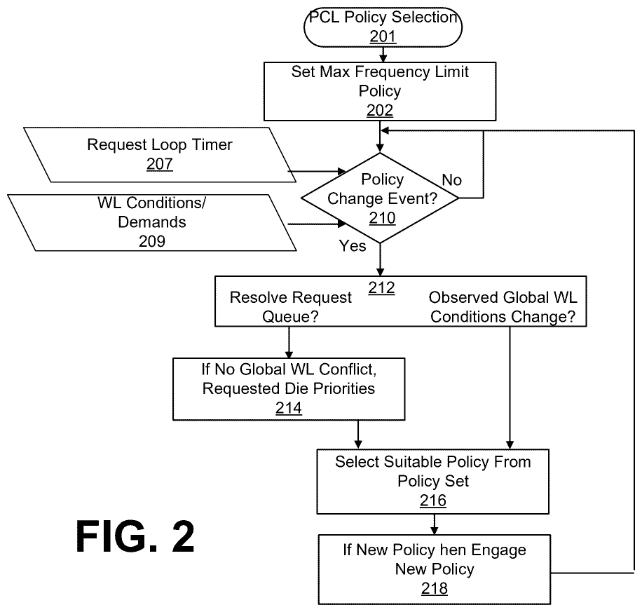

FIG. 2 is a flow diagram showing a routine 201 for selecting a peak current limit (PCL) policy in accordance with some embodiments. For example, this routine may be performed by a PMU such as a root PMU 120 (PMU-1 in FIG. 1). Initially, a policy is selected at 202. This may, for example, be a default, or reset, policy with a nominal operational policy, average expected workloads or the like.

At 210, the routine essentially loops until a policy change event occurs. There are several different ways in which this can happen. In some embodiments, leaf domains are allowed to make requests for a policy change. The requests are coalesced and the root periodically reconciles and services the accumulated request on a periodic basis set for example off of a timer 207, e.g., every milli-second or so. At the same time, the routine can initiate a policy change on its own, for example, based on observed operational package or workload changes, represented at 209. In the case of local IO traffic occurring in a leaf domain that is not visible at the root domain, the root will not automatically grant a higher budget (new peak current limit policy) to the leaf. In this case, the lead should request the root for additional budget (new PCL policy) when it spots higher local IO traffic. Correspondingly, when IO traffic in the leaf has reduced below its thresholds (subject to hysteresis), the leaf should relinquish its Icc_max_p budget by requesting a lower PCL policy.

At 212, it proceeds down one of the event type paths, either the request response path at 214 or observed platform change in conditions path at 216. If the former, at 214, it selects a suitable policy based on a relative priority hierarchy of the leaf domains. For example, they may be assigned relative priorities by the manufacturer, OEM, or datacenter, for example. It makes this requested leaf policy change request decision and engages it at 216 if there are no platform conflicts such as over-riding platform condition changes. On the other hand, if it arrived at 216 as a result of an observed package change in operational conditions such as different workload resource demands, then it selects an appropriate policy from the set of predefined policies. For example, if the workload change is to a network traffic intensive workload, it may select a policy with a high max frequency limit for an IO fabric domain. From here, it returns back to 210 and waits for the next policy change event. An illustrative example is provided below.

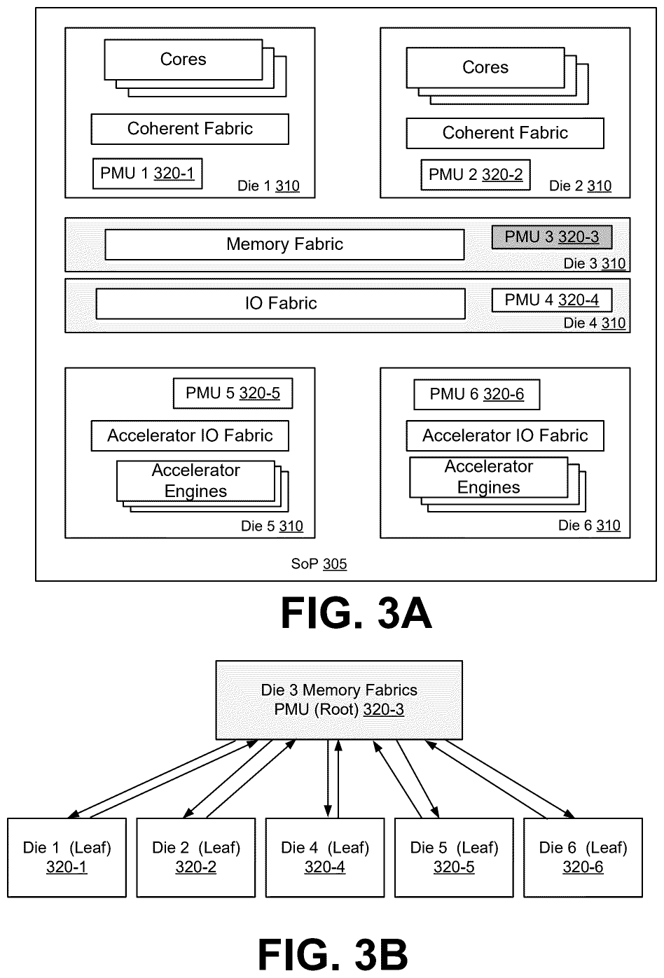

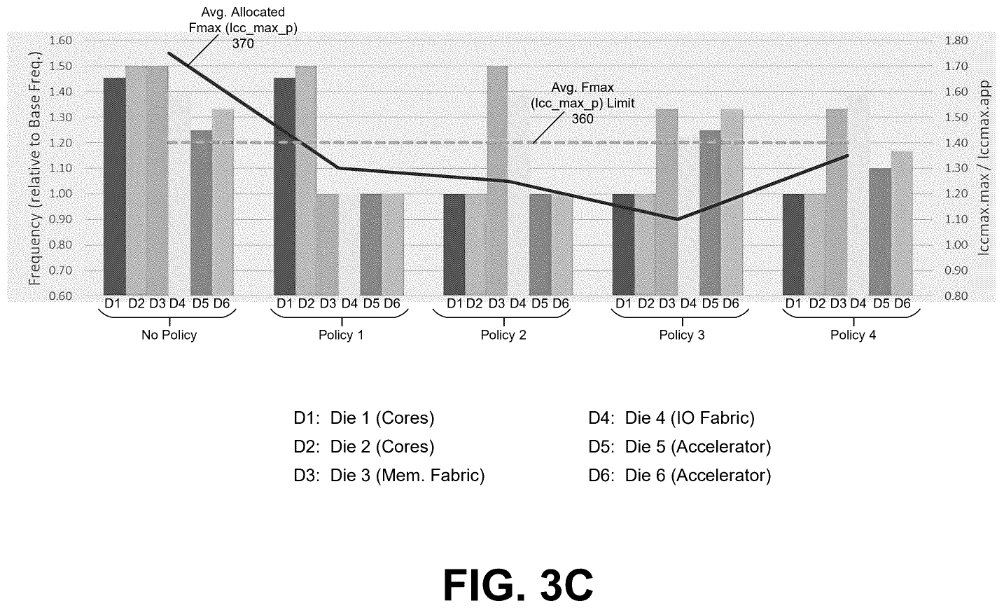

FIGS. 3A-3C are diagrams illustrating an exemplary SoP processing system in accordance with some embodiments. FIG. 3A is a block diagram of the SoP 305; FIG. 3B is a block diagram showing the hierarchical root/leaf communications organization, and FIG. 3C is a chart graphically illustrating exemplary policies for this SoP.

SoP 305 includes six dies 310 (Die 1-Die 6) as shown. Dies 1 and 2 are processing core dies with cores, cache (not shown) and coherent memory fabric for the dies. Die 3 is a memory fabric hub, while Die 4 is an IO (input/output) fabric hub. Dies 5 and 6 are accelerator dies including acceleration engines and acceleration fabrics. The core dies include compute (e.g., CPU) cores, graphics processing cores, artificial intelligence (AI) cores, and;/or the like. The IO fabric hub includes IO controllers (e.g., PCle, UXI, CXL) and fabric for facilitating communications between the package functional blocks and entities such as network interfaces outside of the packages. The memory fabric hub provides high speed access between internal memory and to memory outside of the package such as dynamic random access memory (DRAM). The accelerator engines may be used for various functions such as crypto encoding/decoding, data compression/decompression, AI tasks, graphics, and the like.

Each of the dies also includes a PMU 320 with the PMU for Die 3 (PMU-3) serving as a root PMU. The other PMUs operate as leaf PMUs, as is indicated further in FIG. 3B. With this example, a handshaking communications between the root and leaf PMUs is employed. Leaves can request specific policy changes or they can simply report a change in frequency demand. In some embodiments, they are required to report any decrease of frequency need, relinquishing it in effect to the package. With some handshake schemes, an entity (root or leaf) must send a request and then wait for an acknowledgement before taking an action. The CR registers 130 (from FIG. 1) may be used to convey requests, request states, status, and the like in furtherance of control communications between the root and leaves. In some embodiments, sideband control interconnects may be used to facilitate these communications. For example, when a UCle D2D scheme is employed, its sideband capabilities may be used for this purpose. In some embodiments, in order to avoid over-frequency violations, when a policy change is to occur, the root should ensure that leaves losing frequency (reduced max limits) effectuate their policy changes before activating the leaves whose frequency limits will be increased.

FIG. 3C is a chart illustrating exemplary policies for the system of FIGS. 3A, 3B. There are four exemplary policies (Policy 1-Policy 4), along with a “No Policy” scenario where each domain is given its Icc_max.max current. Note that Icc_max.max is a worst case load current corresponding to when all of a domain's functional blocks are operating at max values (e.g., turbo, POn, etc. Icc_max.app is a vaue corresponding to a baseline operational current, enough for expected steady state performance. This max.app current level corresponds to the base frequency value derived for the domain. Also shown is dashed line 360, which represents the aggregate frequency limit average corresponding to the package Icc_max_p limit. In turn, solid line 370 shows the allocated average max frequency values for the given scenarios. As can be seen, the average allocated level is above the max. frequency threshold when there is no policy in effect resulting in an over-frequency violation. ON the other hand, all of the four designated policies operate with their average max frequency levels coming under the frequency limit. This is so even though they all have domains whose individual frequency limits exceed the average limit threshold 360.

In each of the four policies, some domains are constrained to their base frequency (ratio 1.0) while the remaining domains are allowed to vary up to their unconstrained frequencies. The idea is that even if the domains that are allowed to swing up to their maximum frequency were to run a virus workload, the constrained domains compensate such that the total SoP Icc_max_p (solid line 370) never exceeds its provisioned maximum (dashed line 360).

This is a correct-by-construction benefit that peak current limit policies enable. The platform power delivery can be provisioned to a deterministic target, usually described as a ratio to its baseline current or proxy such as frequency level for the worst case real world application. For this example, the limit has been set to 1.4x. Each policies domain limits are configured so that the policy stays within that design target. Even if new workloads and/or die/package combinations change, or process/design excursions lead to SoP Icc_max_p variations from initial forecasted targets, even late in the design flow, the PCL policies can be adjusted and/or new policies can be added, to continue adhering to the platform power delivery design target provisioned much early in the design phase. This is especially critical since such platform design specifications are typically released to customers early in the design phase and may be extremely difficult to later change.

In operation, for these policy examples, policy selections for root observed conditions and/or priority resolutions may occur in the following manner. For observed condition changes, the root PMU selects one of the policies from the set of available predefined policies that best addresses the currently observed conditions. For example, it might select Policy 1 for a number crunching workload to give higher frequency limits to the core dies (Dies 1, 2), while it might select policy 3 for a network packet processing intensive workload involving compression and encryption, which may benefit from high IO fabric and accelerator frequencies.

The priority orders can be fixed or can be a boot time or runtime selection. This will likely depend on usage models. For priority resolution, the policies in this example might be ordered in the following manner. First: Die 4 (IO hub). If Hub IO bandwidth needs to push this above base frequency, it wins vs. other constraints. Second: Die 3 (hub memory fabric). If Hub Memory BW needs to push this above base frequency, it wins vs. other constraints, apart from IO hub fabric demands. Third/fourth: Dies 5, 6 (Accelerator). Each of the Accelerator chiplets manages frequency requirements for its engines versus the IO fabric internally based on appropriate heuristics. For example, it may boost its fabric frequency when the bandwidth crosses a certain threshold or conversely boost the engines when their utilization crosses a certain threshold. The actual frequency allocation between the engines and the fabric will be dynamically determined depending on heuristics or lookup tables, to ensure that it stays within the Icc_max_p budget allocated to the chiplet within the current PCL policy. Note that the selections can be different in each instance of the core dies. Fifth/Sixth: Dies 1, 2 (Core, Memory LLC Fabric). Each of the core dies manages the max core vs. LLC/memory fabric frequency requirements based on allocated limits (budgets) from the SoP and further trade-offs based on local heuristics (e.g., core-bound vs. chiplet-bound). For example, if the aggregate number of stalls across the whole core die crosses a threshold or the max number stalls across all cores crosses a threshold, the die may internally prioritize and boost its LLC/fabric frequency while clipping the cores to a lower value. The actual number of boost to the fabric vs. clipping of the cores will likely be dynamically determined depending on heuristics or lookup tables, to ensure that it stays within the Icc_max_p budget allocated to the domain within the current PCL policy. This is also referred to as dynamic frequency constraint (DFC). Note that the selections can be different in each instance of a core die.

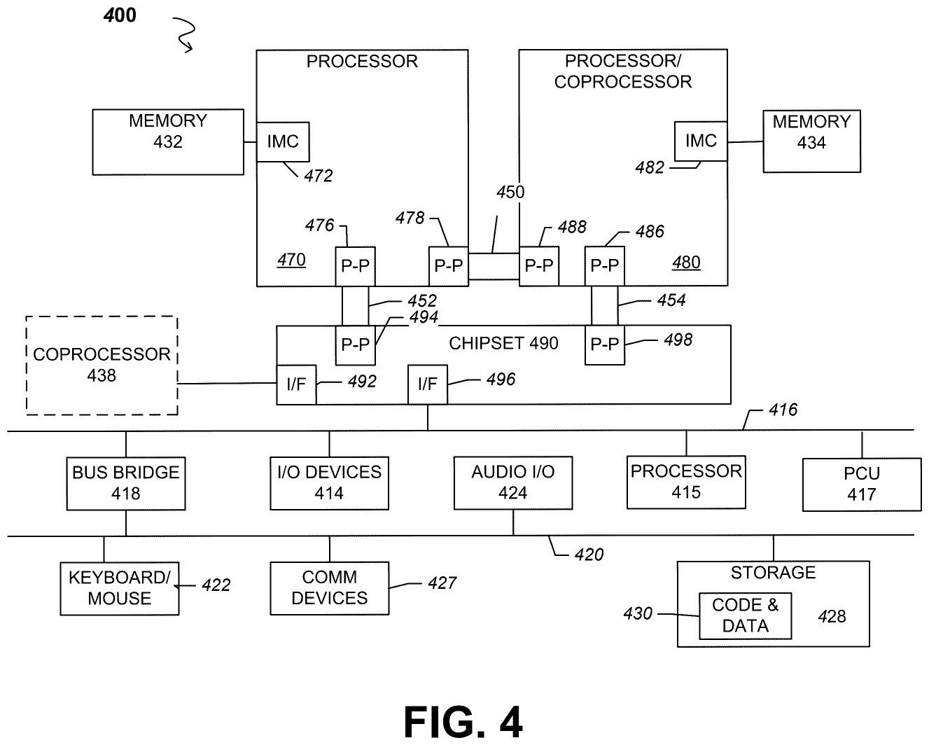

FIG. 4 illustrates an example computing system that may be implemented with a system on package (SoP) as described herein. Multiprocessor system 400 is an interfaced system and includes a plurality of processors including a first processor 470 and a second processor 480 coupled via an interface 450 such as a point-to-point (P-P) interconnect, a fabric, and/or bus. In some examples, the first processor 470 and the second processor 480 are homogeneous. In some examples, first processor 470 and the second processor 480 are heterogenous. Though the example system 400 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 470 and 480 are shown including integrated memory controller (IMC) circuitry 472 and 482, respectively. Processor 470 also includes interface circuits 476 and 478, along with core sets. Similarly, second processor 480 includes interface circuits 486 and 488, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect, or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to one or more voltage regulators (not shown) to cause the voltage regulator(s) to generate the appropriate regulated voltage(s). PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430 and may implement the storage in some examples. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

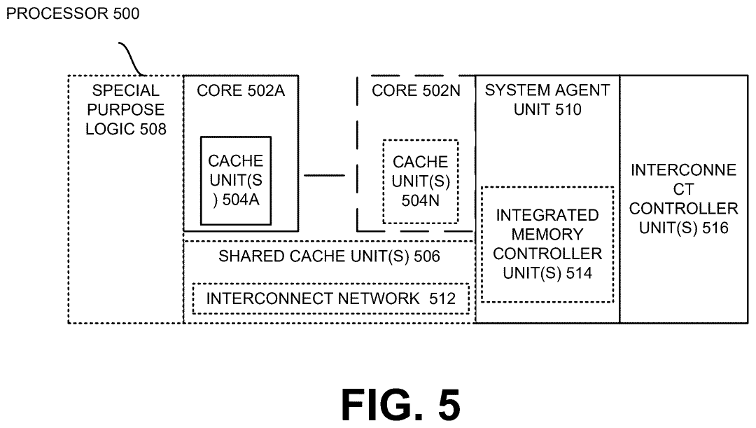

FIG. 5 illustrates a block diagram of an example processor 500 that may be used in the system of FIG. 4 in accordance with some embodiments. The depicted processor may have one or more cores and an integrated memory controller. The solid lined boxes illustrate a processor 500 with a single core 502 (A), system agent unit circuitry 510, and a set of one or more interface controller unit(s) circuitry 516, while the optional addition of the dashed lined boxes illustrates an alternative processor 500 with multiple cores 502 (A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502 (A)-(N) being one or more general purpose cores (e.g., general purpose in-order cores, general purpose out-of-order cores, or a combination of the two); 2) a coprocessor with the cores 502 (A)-(N) being a large number of special purpose cores intended primarily for graphics and/or scientific (throughput); and 3) a coprocessor with the cores 502 (A)-(N) being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504 (A)-(N) within the cores 502 (A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502 (A)-(N). In some examples, interface controller units circuitry 516 couple the cores 502 to one or more other devices 518 such as one or more I/O devices, storage, one or more communication devices (e.g., wireless networking, wired networking, etc.), etc.

In some examples, one or more of the cores 502 (A)-(N) are capable of multi-threading. The system agent unit circuitry 510 includes those components coordinating and operating cores 502 (A)-(N). The system agent unit circuitry 510 may include, for example, power control unit (PCU) circuitry and/or display unit circuitry (not shown). The PCU may be or may include logic and components needed for regulating the power state of the cores 502 (A)-(N) and/or the special purpose logic 508 (e.g., integrated graphics logic). The display unit circuitry is for driving one or more externally connected displays.

The cores 502 (A)-(N) may be homogenous in terms of instruction set architecture (ISA). Alternatively, the cores 502 (A)-(N) may be heterogeneous in terms of ISA; that is, a subset of the cores 502 (A)-(N) may be capable of executing an ISA, while other cores may be capable of executing only a subset of that ISA or another ISA.

Illustrative examples of the technologies disclosed herein are provided below. An embodiment of the technologies may include any one or more, and any compatible combination of, the examples described below.

Example 1 is an apparatus that includes a first integrated circuit (IC) die and a plurality of other dies. The first integrated circuit (IC) die is in a package, and the first die has a first power management unit (PMU) to control current consumption of the first die. The first PMU is a root PMU. The plurality of other IC dies each have a leaf PMU to control its associated die's peak current consumption, the plurality of other dies being a part of the package, and the package has an overall package peak current consumption limit. The first IC die is coupled with the other IC dies such that the root PMU controls the leaf PMUs by issuing to them a peak current limit (PCL) policy from a set of pre-defined PCL policies, wherein each policy includes a set of normalized current limit factors, one for each of the first and other dies, for their PMU to limit the peak current consumption of its associated die, and the sum of the CL factors for each policy correspond to peak current limits that are below the overall package peak current consumption limit.

Example 2 includes the subject matter of example 1, and wherein the root PMU is to issue the policy through a handshaking interconnect process.

Example 3 includes the subject matter of any of examples 1-2, and wherein the root PMU is to select a policy to be issued from the set of predefined policies based on observed telemetry from the first die and plurality of other dies.

Example 4 includes the subject matter of any of examples 1-3, and wherein the first and other dies include a compute core die, an IO fabric die, and an accelerator die.

Example 5 includes the subject matter of any of examples 1-4, and wherein the root is to select a policy having a CL factor for the accelerator die that is at least as high as any of the other CL factors in the selected policy when it observes a high acceleration workload for the package.

Example 6 includes the subject matter of any of examples 1-5, and wherein the root is to select a policy having a CL factor for the IO fabric die that is at least as high as any of the other CL factors in the selected policy when it observes a high network traffic workload for the package.

Example 7 includes the subject matter of any of examples 1-6, and wherein the root PMU is to select a policy to be issued from the set of predefined policies based on one or more policy change requests from the leaf PMUs.

Example 8 includes the subject matter of any of examples 1-7, and wherein the root PMU is to resolve any conflicts between the one or more policy change requests based on a predefined prioritization of the plurality of other dies.

Example 9 includes the subject matter of any of examples 1-8, and wherein the normalized CL factors correspond to frequency budget allocations for the first and plurality of other dies.

Example 10 includes the subject matter of any of examples 1-9, and wherein the CL factor is a value ranging between a baseline value and a peak frequency allocation value, wherein the baseline value is sufficient for its associated die to meet normal steady state operational quality of service (QOS) demands.

Example 11 includes the subject matter of any of examples 1-10, and wherein each of the first and plurality of other IC dies includes memory programmed with policy set parameters for its associated PMU to translate the CL factors to controllable power consuming values.

Example 12 is an apparatus that includes a processing system and a package. The processing system includes a plurality of integrated circuit (IC) dies coupled together through an inter-die communications fabric, each die including a power management unit (PMU) to control power consumption of its associated die. One of the PMUs is a root PMU, and the other PMUs are leaf PMUs, wherein the processing system has a system peak current limit and wherein the root PMU controls the leaf PMUs by issuing to them a peak current limit (PCL) policy from a set of pre-defined PCL policies. Each policy includes a set of normalized current limit factors with at least one for each of the dies wherein the sum of the CL factors for each policy corresponds to an overall peak current limit value that is less than the system peak current limit. The integrated circuit package is formed to house the plurality of IC dies and to couple them to an external power supply to provide current to the processing system.

Example 13 includes the subject matter of example 12, and wherein the root PMU is to issue the policy through a handshaking interconnect process.

Example 14 includes the subject matter of any of examples 12-13, and wherein the root PMU is to select a policy to be issued from the set of predefined policies based on observed telemetry from the plurality of IC dies.

Example 15 includes the subject matter of any of examples 12-14, and wherein the dies include a compute core die, an IO fabric die, and an accelerator die.

Example 16 includes the subject matter of any of examples 12-15, and wherein the root is to select a policy having a CL factor for the accelerator die that is at least as high as any of the other CL factors in the selected policy when it observes a high acceleration workload for the package.

Example 17 includes the subject matter of any of examples 12-16, and wherein the root is to select a policy having a CL factor for the IO fabric die that is at least as high as any of the other CL factors in the selected policy when it observes a high network traffic workload for the package.

Example 18 includes the subject matter of any of examples 12-17, and wherein the root PMU is to select a policy to be issued from the set of predefined policies based on one or more policy change requests from the leaf PMUs.

Example 19 includes the subject matter of any of examples 12-18, and wherein the root PMU is to resolve any conflicts between the one or more policy change requests based on a predefined prioritization of the plurality of dies.

Example 20 includes the subject matter of any of examples 12-19, and wherein the normalized CL factors correspond to frequency budget allocations for the plurality of dies.

Example 21 includes the subject matter of any of examples 12-20, and wherein the CL factor is a value ranging between a baseline value and a peak frequency allocation value, wherein the baseline value is sufficient for its associated die to meet normal steady state operational quality of service (QOS) demands.

Example 22 includes the subject matter of any of examples 12-21, and wherein each of the plurality of IC dies includes memory programmed with policy set parameters for its associated PMU to translate the CL factors to controllable power consuming values.

Example 23 is a computer readable storage medium having instructions that when executed perform a method. The method includes identifying a set of predefined peak current limit (PCL) policies, each having a normalized current limit (CL) factor for an associated domain in a processing system that has a plurality of domains. The method also includes monitoring the processing system to identify changes in workload resource demands, and selecting one of the set of PCL policies to impose on the domains in response to the monitored changes in processing system workload demand.

Example 24 includes the subject matter of example 23, and wherein each of the plurality of domains corresponds to a different integrated circuit (IC) chiplet.

Example 25 includes the subject matter of any of examples 23-24, and comprising selecting a policy based on one or more policy change requests from one or more of the domains.

Example 26 includes the subject matter of any of examples 23-25, and wherein selecting a policy based on one or more policy change requests from one or more of the domains includes resolving any conflicts between the one or more policy change requests based on a predefined prioritization of the plurality of domains.

Example 27 includes the subject matter of any of examples 23-26, and wherein the normalized CL factors correspond to frequency budget allocations for the plurality of domains.

Example 28 includes the subject matter of any of examples 23-27, and wherein the CL factor is a value ranging between a baseline value and a peak frequency allocation value, wherein the baseline value is sufficient for its associated domain to meet normal steady state operational quality of service (QOS) demands.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

For purposes of the embodiments, unless expressly described differently, the transistors in various circuits and logic blocks described herein may be implemented with any suitable transistor type such as field effect transistors (FETs) or bipolar type transistors. FET transistor types may include but are not limited to metal oxide semiconductor (MOS) type FETs such as tri-gate, FinFET, and gate all around (GAA) FET transistors, as well as tunneling FET (TFET) transistors, ferroelectric FET (FeFET) transistors, or other transistor device types such as carbon nanotubes or spintronic devices.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium.

As defined herein, the term “if”' means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context. As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth. It should be appreciated that a logical processor, on the other hand, is a processing abstraction associated with a core, for example when one or more SMT cores are being used such that multiple logical processors may be associated with a given core, for example, in the context of core thread assignment.

It should be appreciated that a processor or processor system may be implemented in various different manners. For example, it may be implemented on a single die, multiple dies (dielets, chiplets), one or more dies in a common package, or one or more dies in multiple packages. Along these lines, some of these blocks may be located separately on different dies or together on two or more different dies. Moreover, multi-chip packages may be implemented in any suitable manner. They may be formed using 3D or 2.5 D methodologies, for example, with circuit boards, interposers and/or bridges for connecting dies, or chiplets, together. Chips may be connected in side-to-side fashions (e.g., using interposers and/or bridges) and/or atop one another, e.g., using hybrid bonding techniques.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An apparatus, comprising:
a first integrated circuit (IC) die in a package, the first die having a first power management unit (PMU) to control current consumption of the first die, the first PMU being a root PMU; and
a plurality of other IC dies, each having a leaf PMU to control its associated die's peak current consumption, the plurality of other dies being a part of the package, the package having an overall package peak current consumption limit;
wherein the first IC die is coupled with the other IC dies such that the root PMU controls the leaf PMUs by issuing to them a peak current limit (PCL) policy from a set of pre-defined PCL policies, wherein each policy from the predefined set includes a set of normalized current limit (CL) factors, one for each of the first and other dies, for their PMU to limit the peak current consumption of its associated die, and wherein the sum of the CL factors for each policy correspond to peak current limits that are below the overall package peak current consumption limit.

2. The apparatus of claim 1, wherein the root PMU is to issue the policy through a handshaking interconnect process.

3. The apparatus of claim 1, wherein the root PMU is to select a policy to be issued from the set of predefined policies based on observed telemetry from the first die and plurality of other dies.

4. The apparatus of claim 3, wherein the first and other dies include a compute core die, an IO fabric die, and an accelerator die.

5. The apparatus of claim 4, wherein the root PMU is to select a policy having a CL factor for the accelerator die that is at least as high as any of the other CL factors in the selected policy when it observes a high acceleration workload for the package.

6. The apparatus of claim 4, wherein the root PMU is to select a policy having a CL factor for the IO fabric die that is at least as high as any of the other CL factors in the selected policy when it observes an intensive network traffic workload for the package.

7. The apparatus of claim 1, wherein the root PMU is to select a policy to be issued from the set of predefined policies based on one or more policy change requests from the leaf PMUs.

8. The apparatus of claim 7, wherein the root PMU is to resolve any conflicts between the one or more policy change requests based on a predefined prioritization of the plurality of other dies.

9. The apparatus of claim 1, wherein the normalized CL factors correspond to frequency budget allocations for the first and plurality of other dies.

10. The apparatus of claim 9, wherein the CL factor is a value ranging between a baseline value and a peak frequency allocation value, wherein the baseline value is sufficient for its associated die to meet normal steady state operational quality of service (QOS) demands.

11. The apparatus of claim 1, wherein each of the first and plurality of other IC dies includes memory programmed with policy set parameters for its associated PMU to translate the CL factors to controllable power consuming values.

12. An apparatus, comprising:
a processing system including a plurality of integrated circuit (IC) dies coupled together through an inter-die communications fabric, each die including a power management unit (PMU) to control power consumption of its associated die, wherein one of the PMUs is a root PMU, and the other PMUs are leaf PMUs, wherein the processing system has a system peak current limit and wherein the root PMU controls the leaf PMUs by issuing to them a peak current limit (PCL) policy from a set of pre-defined PCL policies, each policy including a set of normalized current limit factors with at least one for each of the dies wherein the sum of the CL factors for each policy correspond to an overall peak current limit value that is less than the system peak current limit; and
an integrated circuit package formed to house the plurality of IC dies and to couple them to an external power supply to provide current to the processing system.

13. The apparatus of claim 12, wherein the root PMU is to issue the policy through a handshaking interconnect process.

14. The apparatus of claim 12, wherein the root PMU is to select a policy to be issued from the set of predefined policies based on observed telemetry from the plurality of IC dies.

15. The apparatus of claim 12, wherein the root PMU is to select a policy to be issued from the set of predefined policies based on one or more policy change requests from the leaf PMUs.

16. The apparatus of claim 12, wherein the normalized CL factors correspond to frequency budget allocations for the plurality of dies.

17. The apparatus of claim 16, wherein the CL factor is a value ranging between a baseline value and a peak frequency allocation value, wherein the baseline value is sufficient for its associated die to meet normal steady state operational quality of service (QOS) demands.

18. A computer readable storage medium having instructions that when executed perform a method comprising:
identifying a set of predefined peak current limit (PCL) policies, each having a normalized current limit (CL) factor for an associated domain in a processing system that has a plurality of domains;
monitoring the processing system to identify changes in workload resource demands; and
selecting one of the set of PCL policies to impose on the domains in response to the monitored changes in processing system workload demand.

19. The storage medium of claim 18, wherein each of the plurality of domains corresponds to a different integrated circuit (IC) chiplet.

20. The storage medium of claim 18, comprising selecting a policy based on one or more policy change requests from one or more of the domains.
